(19) United States
(12) Patent Application Publication
(10) Pub. No.: US 2013/0227349 A1
(43) Pub. Date: Aug. 29, 2013

(54) CLOUD BROKERING METHOD AND APPARATUS IN HETEROGENEOUS CLOUD ENVIRONMENT

(71) Applicant: Electronics and Telecommunications Research Institute, (US)

(72) Inventors: Kodirov NODIR, Daejeon (KR); Jae Gi LEE, Daejeon (KR); Taesang CHOI, Daejeon (KR)

(73) Assignee: Electronics and Telecommunications Research Institute, Daejeon (KR)

(21) Appl. No.: 13/774,170

(22) Filed: Feb. 22, 2013

(30) Foreign Application Priority Data
Feb. 24, 2012 (KR) 10-2012-0019298

(51) Int. Cl. G06F 11/07

(52) U.S. Cl. CPC G06F 11/0778
USPC 714/37

(57) ABSTRACT

In a multi-cloud environment including a plurality of cloud systems, an apparatus, that is, a cloud brokering apparatus, obtains data streamed from the cloud systems and converts the obtained data into a predetermined format. The cloud brokering apparatus performs analysis which includes determining whether a fault occurs and whether an agreed service level for the normalized data is satisfied, and provides the analyzed data to a management system of a high level.

### CROSS-REFERENCE TO RELATED APPLICATION

This application claims priority to and the benefit of Korean Patent Application No. 10-2012-0019298 filed in the Korean Intellectual Property Office on Feb. 24, 2012, the entire contents of which are incorporated herein by reference.

### BACKGROUND OF THE INVENTION

(a) Field of the Invention

The present invention relates to a method and apparatus for performing cloud brokering in a heterogeneous cloud environment in which there are various cloud systems.

(b) Description of the Related Art

Cloud computing is a type of distributed computing environment in which a plurality of computing resources move to a region, for example, a cloud region, having computing functions in order to be used by users anytime and anywhere, and a charge for computing resources used is levied. A plurality of physical or logical servers exist in the cloud region, and are referred to as cloud resources. The cloud resources are connected through a network.

Recently, a multi-cloud service for integrating and managing various cloud computing environments has been developed. In order to provide a multi-cloud service, a multi-cloud engine as a heterogeneous management unit or an autonomic brokering agent (ABA) has been developed.

A multi-cloud engine is restricted to processing application programming interfaces from different cloud vendors, while the ABA is not restricted thereto. The ABA may obtain additional information and provide it to a high level function device through an individual agent. For example, the ABA may obtain and analyze logs transmitted from cloud environments.

The above information disclosed in this Background section is only for enhancement of understanding of the background of the invention and therefore it may contain information that does not form the prior art that is already known in this country to a person of ordinary skill in the art.

### SUMMARY OF THE INVENTION

The present invention has been made in an effort to provide a brokering method and apparatus for efficiently performing communication between cloud systems and a management system in heterogeneous cloud environments in which different cloud services are provided.

An exemplary embodiment of the present invention provides a method for performing brokering in a multi-cloud environment including a plurality of cloud systems. The method includes: obtaining data streamed from the cloud systems; performing normalizing for converting the obtained data into a predetermined format; performing analysis which includes determining whether a fault occurs and whether an agreed service level for the normalized data is satisfied; and providing the analyzed data to a management system of a high level.

Here, the obtaining of data may include obtaining log data generated by a cloud system or results returned from a cloud system after executing a specific command.

The performing of analysis may include: determining whether a fault occurs based on the management data; determining whether the management data is in violation of a service level agreement (SLA) of the agreed service level; and obtaining management data which includes no fault and satisfies the SLA.

Also, the providing of the analyzed data may include providing the management data which includes no fault and satisfies the SLA among the analyzed management data to the management.

In addition, the method may further include receiving a command from the management system and executing it.

In this case, the receiving of a command may include: mapping the command to a corresponding cloud system; converting the command into a format corresponding to the cloud system; and executing the converted command.

Another embodiment of the present invention provides an apparatus for performing brokering in a multi-cloud environment including a plurality of cloud systems. The apparatus includes a data obtaining unit for obtaining data streamed from the cloud systems and performing normalizing which converts the obtained data into a predetermined format; a fault detection unit for determining whether a fault occurs in the normalized data; and a service level confirmation unit for determining whether the normalized data satisfies a service level agreement (SLA).

In addition, the apparatus may further include a management agent for providing the analyzed data to a management system of a high level and receiving a command from the management system.

Also, the apparatus may further include: a command obtaining unit for receiving the command from the management agent and mapping the command to a corresponding cloud system; and a command execution unit for converting the command into a format corresponding to the cloud system and executing it.

Meanwhile, the management agent may provide data of which there is no fault and satisfies the SLA among the normalized data to the management system, or store the data in a database.

### BRIEF DESCRIPTION OF THE DRAWINGS

FIG. 1 shows a network environment of a cloud brokering apparatus according to an exemplary embodiment of the present invention.

FIG. 2 shows a structure of a cloud brokering apparatus according to an exemplary embodiment of the present invention.

FIG. 3 shows an example of connection between a cloud brokering apparatus and a management system in a high level layer according to an exemplary embodiment of the present invention.

FIG. 4 shows an operation relationship between constituent elements in a cloud brokering method according to an exemplary embodiment of the present invention.

FIG. 5 and FIG. 6 show flowcharts of a cloud brokering method according to an exemplary embodiment of the present invention.

FIG. 7 shows which elements of the brokering apparatus operate in steps of the brokering method according to an exemplary embodiment of the present invention.

### DETAILED DESCRIPTION OF THE EMBODIMENTS

In the following detailed description, only certain exemplary embodiments of the present invention have been shown and described, simply by way of illustration. As those skilled in the art would realize, the described embodiments may be modified in various different ways, all without departing from the spirit or scope of the present invention.

Accordingly, the drawings and description are to be regarded as illustrative in nature and not restrictive. Like reference numerals designate like elements throughout the specification.

Through the specification, in addition, unless explicitly described to the contrary, the word “comprise” and variations such as “comprises” or “comprising” will be understood to imply the inclusion of stated elements but not the exclusion of any other elements.

Next, referring to the drawings, a cloud brokering method and apparatus in a heterogeneous cloud environment according to an exemplary embodiment of the present invention will be described.

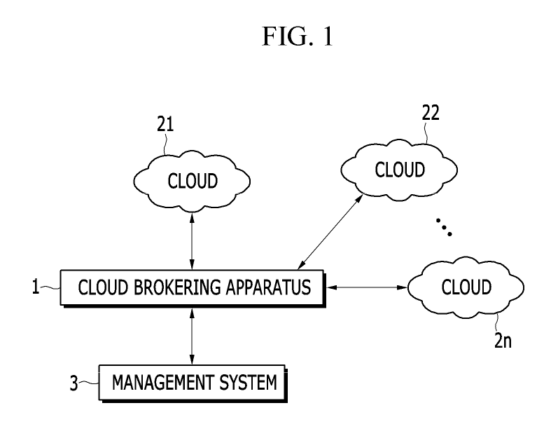

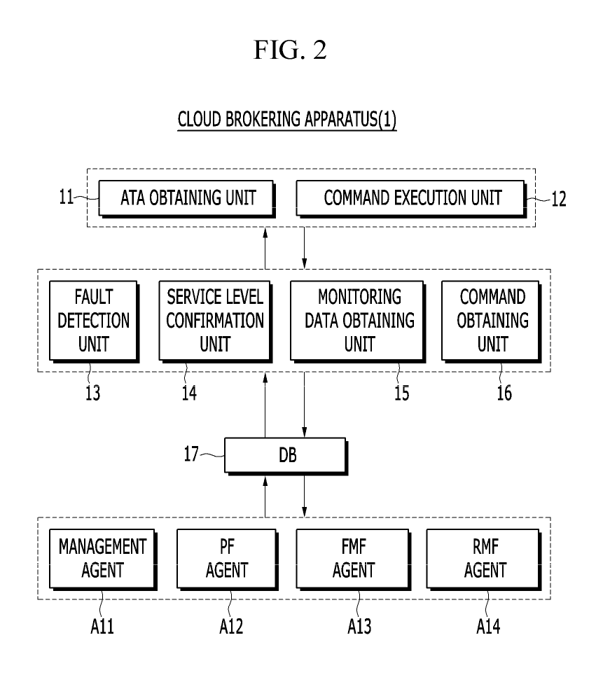

FIG. 1 shows a network environment of a cloud brokering apparatus according to an exemplary embodiment of the present invention, and FIG. 2 shows a structure of a cloud brokering apparatus according to an exemplary embodiment of the present invention.

As shown in FIG. 1, a cloud brokering apparatus 1 according to an exemplary embodiment of the present invention performs interfacing between cloud systems 21, 22, . . . , 2n for providing a plurality of various cloud services and a management system 3 in a heterogeneous cloud environment, that is, a multi-cloud environment.

The management system 3 may be a cloud data center. In this case, the cloud brokering apparatus 1 may be embodied in a type of management node of the cloud data center.

The cloud brokering apparatus 1 according to an exemplary embodiment of the present invention (hereinafter, for better comprehension and ease of description, it will be referred to as a brokering apparatus) communicates, as shown in FIG. 2, with the management system 3 of a single management interface apparatus and each cloud system in a multi-cloud environment to integrate and manage different cloud systems. For this purpose, the brokering apparatus 1 includes a data obtaining unit 11, a command execution unit 12, a fault detection unit 13, a service level confirmation unit 14, a monitoring data obtaining unit 15, a command obtaining unit 16, and a database (DB) 17 of a storage device.

The data obtaining unit 11 obtains data from different cloud systems, and more particularly, log data from each cloud system. In an exemplary embodiment of the present invention, the data obtained from each cloud system will be generally referred to as “management data,” and the management data includes log data generated by a cloud system or results returned from a cloud system after executing a specific command.

The data obtaining unit 11 converts and outputs the obtained management data in a predetermined format (e.g., XML).

The command execution unit 12 is provided with a command (e.g., DoNodeSpecific) from the management system 1 and executes the command.

The command execution unit 12 is provided with a command from the command obtaining unit 16, converts the command into a format corresponding to a cloud system, and executes the converted command.

Through the data obtaining unit 11 and the command execution unit 12, bi-directional communication between the plurality of cloud systems and the management system 3 may be performed. The data obtaining unit 11 and the command execution unit 12 together will be referred to as a normalizing unit.

Meanwhile, the fault detection unit 13 determines whether there is a fault in a real or virtual cloud resource, and more specifically, determines whether there is a fault in a cloud resource based on the management data output from the normalizing unit.

The service level confirmation unit 14 determines whether data to be input is in violation of an agreed service level. A service level agreement (SLA) is made to guarantee quality of service (QoS). In the SLA, a service level by quantification is distinctly presented, and compensation for the case in which a level of cloud service satisfies the suggested service level is performed. The service level confirmation unit 14 determines whether the management data from the data obtaining unit 11 satisfies the agreed service level. Here, according to the results of the determining a fault and a service level, a fault recovery agent or a cloud resource reprovision agent is called so that the fault may be recovered or resources may be provided again to approach the agreed service level.

Meanwhile, the monitoring data obtaining unit 15 obtains management data in which there is no fault and the agreed service level is satisfied. The management data is collected as monitoring data.

The command obtaining unit 16 is provided with a command from the management system 3, and provides it to the command execution unit 12. Here, the command obtaining unit 16 may match the command to a node, that is, a cloud system, and provide it to the command execution unit 12.

The fault detection unit 13, the service level confirmation unit 14, the monitoring data obtaining unit 15, and the command obtaining unit 16 together may be referred to as an analyzing unit.

The DB 17 stores and manages the monitoring data processed through the normalizing unit and the analyzing unit.

The brokering apparatus 1 further includes a management agent A11 to interface with the management system 3, and may further include a provisioning function (PF) agent A12, a fault management function (FMF) agent A13, and a resource management function (RMF) agent A14.

The PF agent A12 provides an interface with a module (that is, a PF module) for providing resources of the management system 3, the FMF agent A13 provides an interface with a module (that is, an FMF module) for managing faults of the management system 3, and the RMF agent A14 provides an interface with a module (that is, an RMF module) for managing resources of the management system 3.

The management agent A11 stores and manages the monitoring data. The management agent A11 functions as a database and may also be embodied in a type of various storage devices. The monitoring data stored and managed in the management agent A11 are read, and new data for providing cloud resources from various agents may be input to the management agent A11.

These agents interconnect with modules for performing other management functions of the management system 3 in a higher level architecture, and issue commands for cloud resource provision, fault management, and other management functions.

The management agent A11, the PF agent A12, the FMF agent A13, and the RMF agent A14 together may be referred to as “an interface agent”.

The brokering apparatus 1 according to the exemplary embodiment of the present invention may be connected to an apparatus of a high level in a higher level architecture, that is, the management system 3.

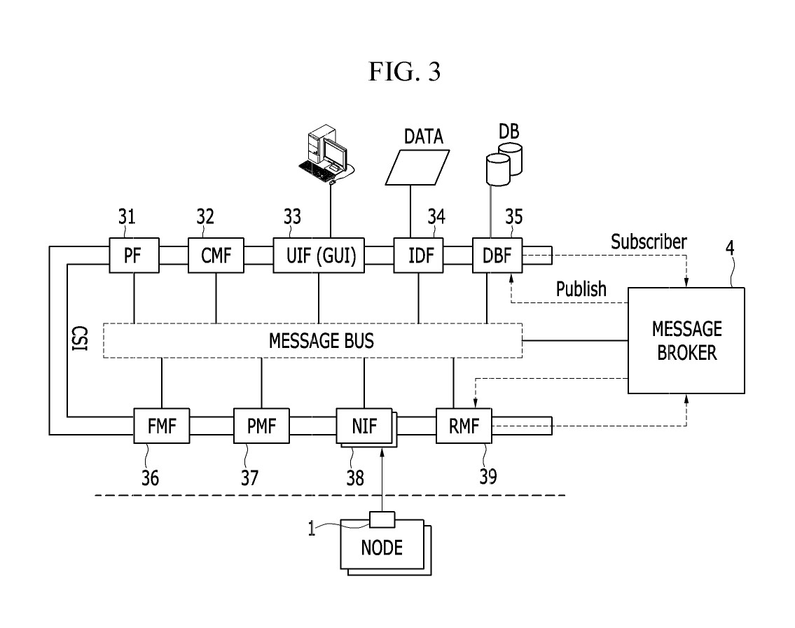

FIG. 3 shows an example of connection between a cloud brokering apparatus and a management system in a high level layer according to an exemplary embodiment of the present invention.

As shown in FIG. 3, the brokering apparatus 1 according to an exemplary embodiment of the present invention may communicate with a plurality of function modules of the management system 3 through a message bus.

The management system 3 performs network management and service provision in a multi-cloud environment, and provides management functions such as service provision and performance and fault management. For this purpose, the management system 3 (e.g., a HiMang management system) includes a plurality of function processors, that is, function modules as shown in FIG. 3. The function modules include a provision function (PF) module 31, a cognitive management function (CMF) module 32, a user interface function (UIF) module 33, an in-memory data manager function (IDF) module 34, database function (DBF) module 35, a fault management function (FMF) module 36, a performance monitoring function (PMF) module 37, a node interface function (NIF) module 38, and a resource management function (RMF) module 39.

Each of the modules transmit and receive information with each other through a message broker 4, and the message broker 4 provides a consistent and extensible interface for transmitting/receiving between each module 31-39 or transmitting/receiving with an external apparatus.

Meanwhile, there may be a message of a high priority system fault which cannot be autonomously solved by the management system 3. In this case, the message of a high priority system fault is directly transmitted to the UIF module 33 to provide it to a user in real time. The UIF module 33 may ask the user to perform a particular action for recovering the fault. Otherwise, the message of the high priority system fault may be autonomously exchanged among the modules through the message broker 4.

Next, a brokering method according to an exemplary embodiment of the present invention will be described.

The brokering method according to an exemplary embodiment of the present invention includes a normalizing step and an analysis step.

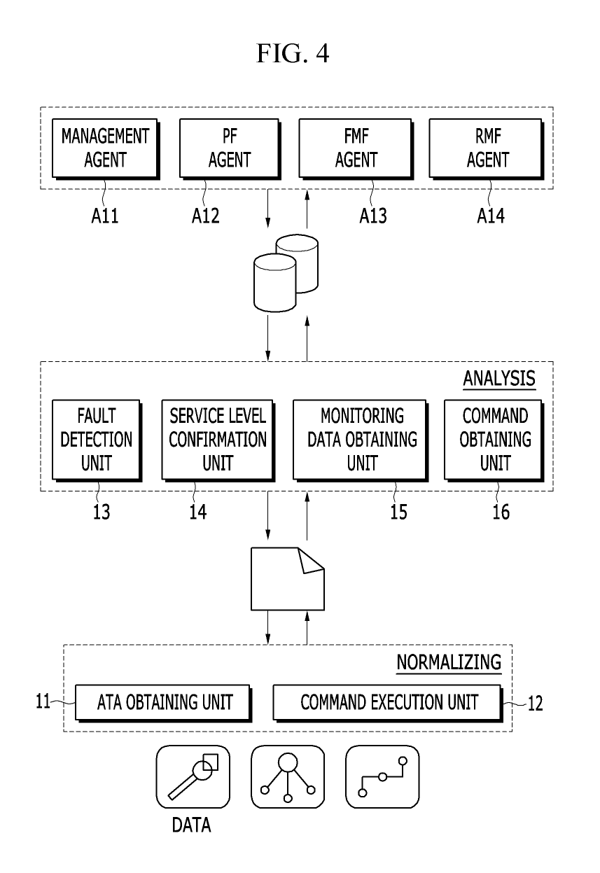

FIG. 4 shows an operation relationship between constituent elements in a cloud brokering method according to an exemplary embodiment of the present invention.

In the normalizing step, as shown in FIG. 4, management data from different cloud resources is obtained and is then converted and output in the same format. Here, cloud specific data (e.g., DoStandardData) and an execution management command (e.g., DoNodeSpecific) may be obtained, be normalized with the same format, and be output.

The analysis step includes three steps. The three steps include, for example as shown in FIG. 4, a fault check step, an SLA check step for determining whether the agreed service level is satisfied, and an analysis result processing step, which may be sequentially performed.

It is determined whether there is a fault in a real or virtual resource in the fault check step, and it is determined whether input data is in violation of the agreed service level in the SLA check step. In the analysis result processing step, a fault recovery agent or a cloud resource reprovision agent is called so that the fault may recovered or resources may be provided again to approach the agreed service level.

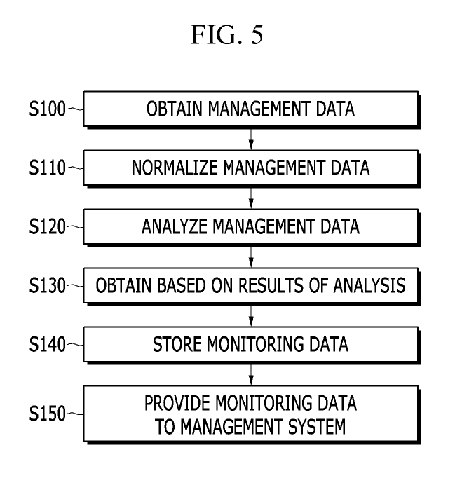

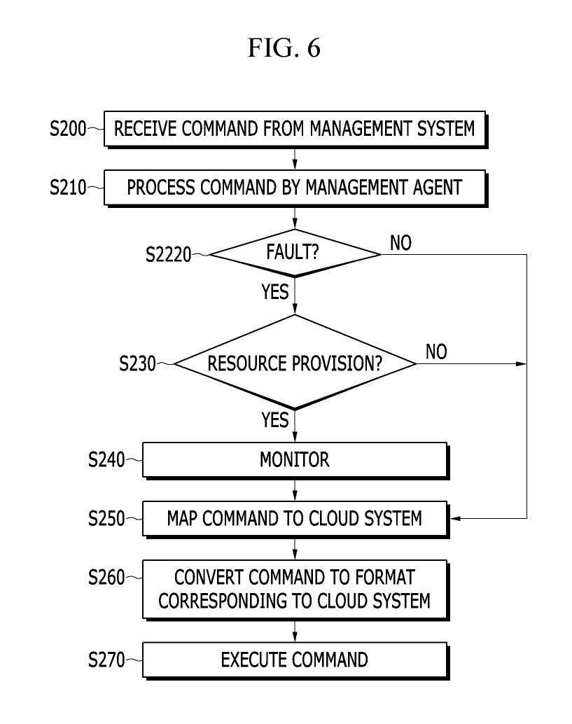

FIG. 5 and FIG. 6 show flowcharts of a cloud brokering method according to an exemplary embodiment of the present invention. Particularly, FIG. 5 shows a brokering method for obtaining data from a cloud system and providing it to the management system, and FIG. 6 shows a brokering method for receiving a command from the management system and providing it to a cloud system.

First, the brokering method for obtaining data from a cloud system and providing it to the management system will be described.

As shown in FIG. 5, the brokering apparatus 1 obtains management data of a log type in a multi-cloud environment (S100).

The obtained management data is normalized with the same format (S110). Here, specific log entries may be stored and processed as standard output for analysis.

The management data processed through the normalizing step is analyzed and processed in the analysis step (S120). Specifically, the brokering apparatus 1 determines whether there is a fault based on the management data, and determines whether the management data is in violation of the agreed service level based on the management data. Based on the result of the determining, the management data for including no fault and satisfying the agreed service level is obtained as monitoring data. The monitoring data may be stored and managed in the DB 17 or the management agent 11, and may also be referred to as plain monitoring data.

The management agent A11 reads the plain monitoring data from the DB 17 and provides it to an apparatus for performing a high level management function, that is, the management system 3. After this, cloud management including cloud resource provision and fault recover is performed by modules of the management system 3.

Meanwhile, after the management system 3 performs main management logic, commanding including resource provision, fault recovery, and monitoring may be performed in a cloud system.

For this purpose, as shown in FIG. 6, a command related to one among resource provision, fault recovery, and monitoring may be provided to the brokering apparatus 1 from the management system 3 (S200). Here, the command is provided to the management agent A11 of the brokering apparatus 1 (S210). The management agent A11 determines which one the command is related to among resource provision, fault recovery, and monitoring, and a related operation is performed based on the result of the determining.

When the command is related to the fault recovery, the resource provision, or the monitoring (S220, S230, and S240), the management agent A11 provides the command to the command obtaining unit 16. The command obtaining unit determines which cloud system the command is related to and maps the command to the related cloud system (S250). The command execution unit 12 converts the command into a format suitable for the mapped cloud system and executes it (S260 and S270).

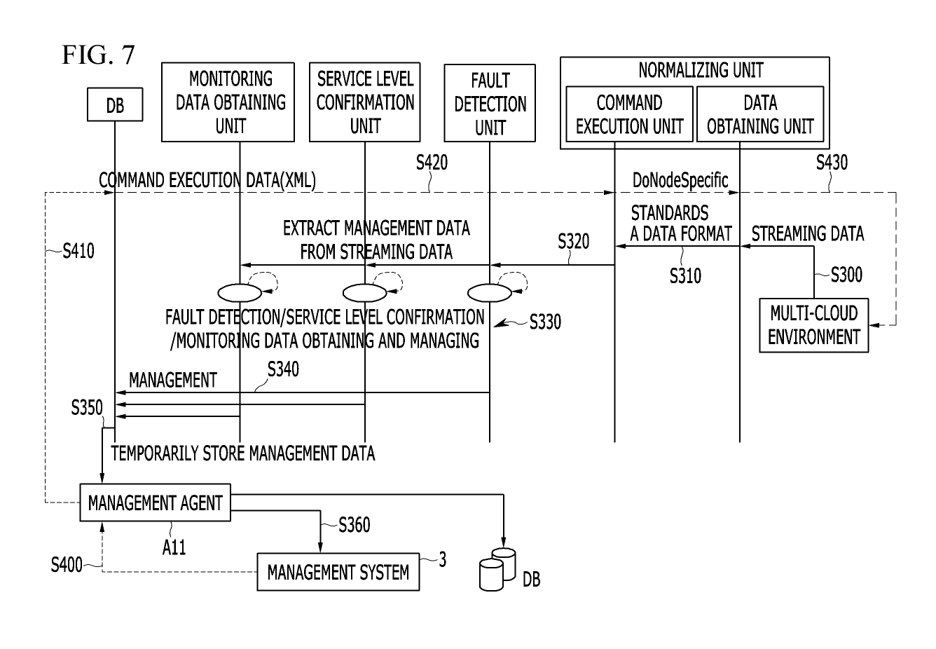

The brokering method according to an exemplary embodiment of the present invention is more specifically shown in FIG. 7. FIG. 7 shows which elements of the brokering apparatus operate in steps of the brokering method according to an exemplary embodiment of the present invention. In FIG. 7, the solid line represents a procedure of obtaining and processing data in a cloud environment as in FIG. 6, and the dotted line represents a procedure of obtaining and processing data from the management system as in FIG. 6.

In a multi-cloud environment including smart nodes, referring to FIG. 7, the data obtaining unit 11 of the brokering apparatus 1 collects data being streamed by each cloud system, and particularly obtains management data of a log type (S300). The data obtaining unit 11 performs normalizing to the management data, and specific log entries are stored and processed as standard output for analysis (S310).

Through the above normalizing step, the management data output from the data obtaining unit 11 is analyzed and processed in the analysis step. More specifically, the fault detection unit 13 determines whether there is a fault based on the management data from the data obtaining unit 11, and the service level confirmation unit 14 determines whether the management data is in violation of the agreed service level. Base on the results of the determining, the monitoring data obtaining unit 15 obtains management data for including no fault and satisfying the agreed service level as monitoring data (S320-S340). The monitoring data is provided to the management agent A11 (S350). The management agent A11 temporally stores the monitoring data and then provides the management data to the management system 3 (S360) or stores it to the DB 17. Here, the monitoring data may be provided to the management system 3 for performing a management function (e.g., a HiMang management function) of a high level to be processed.

Meanwhile, the commands generated based on the management function of the management system 3 are provided to the management agent A11 (S400), and the management agent A11 provides them to the command execution unit 12 through the command obtaining unit 16 (S410 and S420). The commands are converted into a format suitable to a corresponding cloud system and are then executed (S430).

According to the exemplary embodiment of the present invention, in a multi-cloud environment including a plurality of various cloud systems, brokering is performed to efficiently communicate between a management system of a high level and each cloud system.

The brokering is not restricted to processing an application programming interface (API) between the management system of a high level and each cloud system. The brokering processes data as well as commands related to each cloud system, and thus efficient management including fault recovery and resource provision can be performed.

The above-mentioned exemplary embodiments of the present invention are not embodied only by an apparatus and method. Alternatively, the above-mentioned exemplary embodiments may be embodied by a program performing functions that correspond to the configuration of the exemplary embodiments of the present invention, or a recording medium on which the program is recorded. While this invention has been described in connection with what is presently considered to be practical exemplary embodiments, it is to be understood that the invention is not limited to the disclosed embodiments, but, on the contrary, is intended to cover various modifications and equivalent arrangements included within the spirit and scope of the appended claims.

What is claimed is:

1. A method for performing brokering in a multi-cloud environment including a plurality of cloud systems, the method comprising:
obtaining data streamed from the cloud systems;
performing normalizing for converting the obtained data into a predetermined format;
performing analysis which includes determining whether a fault occurs and a service level satisfies an agreed service level for the normalized data; and
providing the analyzed data to a management system of a high level.

2. The method of claim 1, wherein the obtaining of data includes obtaining log data generated by a cloud system or results returned from a cloud system after executing a specific command.

3. The method of claim 2, wherein the performing of analysis includes:
determining whether a fault occurs based on the management data;
determining whether the management data is in violation of a service level agreement (SLA) of the agreed service level; and
obtaining management data which includes no fault and satisfies the SLA.

4. The method of claim 3, wherein the providing of the analyzed data includes providing the management data which includes no fault and satisfies the SLA among the analyzed management data to the management.

5. The method of claim 1, further comprising
receiving a command from the management system and executing it.

6. The method of claim 5, wherein the receiving of a command includes:
mapping the command to a corresponding cloud system;
converting the command into a format corresponding to the cloud system; and
executing the converted command.

7. An apparatus for performing brokering in a multi-cloud environment including a plurality of cloud systems, the apparatus comprising:
a data obtaining unit for obtaining data streamed from the cloud systems and performing normalizing which converts the obtained data into a predetermined format;
a fault detection unit for determining whether a fault occurs in the normalized data; and
a service level confirmation unit for determining whether the normalized data satisfies a service level agreement (SLA).

8. The apparatus of claim 7, further comprising
a management agent for providing the analyzed data to a management system of a high level and receiving a command from the management system.

9. The apparatus of claim 8, further comprising:
a command obtaining unit for receiving the command from the management agent and mapping the command to a correspond cloud system; and
a command execution unit for converting the command into a format corresponding to the cloud system and executing it.

10. The apparatus of claim 8, wherein the management agent provides data of which there is no fault and satisfies the SLA among the normalized data to the management system, or stores the data in a database.

11. The apparatus of claim 7, wherein the data obtaining unit obtains log data generated by a cloud system or results returned from a cloud system after executing a specific command and normalizes them.
